(19) United States
(12) Patent Application Publication
(10) Pub. No.: US 2021/0362458 A1
(43) Pub. Date: Nov. 25, 2021

(54) IMPROVEMENT TO EMBOSSING ASSEMBLY FOR PROCESSING PAPER

(71) Applicant: Jose Antonio LOGIODICE, São Paulo (BR)

(72) Inventor: Jose Antonio LOGIODICE, São Paulo (BR)

(21) Appl. No.: 17/059,730

(22) PCT Filed: May 29, 2018
(86) PCT No.: PCT/BR2018/050176

§ 371 Date: Nov. 30, 2020

(51) Int. Cl. B31F 1/07

(52) U.S. Cl. CPC B31F 1/07; B31F 2201/0787; B31F 2201/0764; B31F 2201/0735

(57) ABSTRACT

IMPROVEMENT TO AN EMBOSSING ASSEMBLY FOR PAPER PROCESSING, comprising two independent embossing rollers (1a) and (1b), and the respective press rollers (2a) and (2b), forming two embossing lines, for two layers of paper (Pa) and (Pb); the two embossing rollers (1a) and (1b) have their diameters with reliefs (3a) and (3b) distributed on parallel embossing rows of two paper layers (Pa) and (Pb); at least one of the embossing lines includes a glue applying station (4) with glue transferring rollers (5), one of which is in contact with the corresponding embossing roller (1a); a third press roller (2c) works with the first embossing roller (1a) and, at this point, the two paper layers (Pa) and (Pb) pass, already embossed and overlapped, fitted between themselves and glued; the precise integration of both paper layers (Pa) and (Pb) occurs due to an angular shift (α) previously defined between the relief rows (3a) and (3b) of the embossing cylinders (1a-1b).

### TECHNICAL DOMAIN

More specifically, this invention refers to technical and functional enhancements in the mechanical arrangement of a set of cylinders for the mirrored embossing of two continuous layers of paper, which, after being embossed, are overlapped and joined at the edges or at any point of their width, forming paper that is bulky and soft, and the embossing also defines a decorative relief pattern to enhance the appearance of the product, which, in this case, can be any product provided in a roll or folded, notably toilet paper, paper towels, paper tissue, paper napkins and others with similar characteristics.

### STATE OF THE ART

As it is known, currently, embossing is a technique widely used to change the texture, tactile feel, volume and appearance of specific products made out of sheets of paper, some provided in rolls and other in folded sheets, such as toilet paper, paper towels, paper tissue, paper napkins and others. All of them can be produced with one or more layers, usually two. Each layer undergoes an embossing process, which, in brief, could be explained as a process similar to stamping, in which the mechanical means used exert pressure over the smooth surface of the material, causing a plurality of deformations in relief, which are combined in order to define an embossing pattern, from the simplest ones defined by geometric details, to the most elaborate, which form true works of art. Thus, embossing technology became an efficient resource to alter characteristics of a sheet of paper, especially when it is formed by two or more layers, providing important advantages, i.e. initially, embossing changes the paper's texture, making it much softer and more delicate, which makes it pleasant to the touch. Likewise, by changing the texture, the volume is also substantially increased, i.e. the paper sheet no longer has a “compact” effect and acquires a more “light and soft” aspect, all with the same amount of paper. In regards to appearance, without a doubt, embossing defines decorated surfaces on one or both sides of the paper. Logically, the “die” employed for embossing allows for a variety of combinations of reliefs that may be combined to obtain all sorts of designs, which significantly improves the visual aspect of the paper, suggesting good quality and origin, adding more resources to establish the product brand with the final consumer.

Different pieces of equipment are currently known to be used for paper embossing, all combining a series of engraved and non-engraved cylinders, some made out of metal and others out of rubber, as well as molds and countermolds, which are engraved; but, regardless of said aspects, each machine has its particular characteristics inherent to the finished product, as taught by the following documents: BRP10512124—support equipment for embossing rollers, and method for the exchange of one or more embossing rollers; BRPI1101330—continuous paper product stamping apparatus; BRP10813705—device for treating paper webs or sheet thicknesses; BRPI1101330—continuous paper product stamping apparatus; BR102013026900—embosser set for paper processing. WO2009010999A1 device for treating paper rolls; WO2010016081A1—paper texture treatment roller; US2010181040—device for treating paper rolls; U.S. Pat. No. 8,246,885—method and assembly for the manufacture of an absorbent sheet and obtained absorbent sheet; U.S. Pat. No. 8,216,427—structuring belt, press section and papermaking machine for the manufacture of a high volume crimped tissue paper web and its method; U.S. Pat. No. 8,210,102—switch processing method and apparatus; U.S. Pat. No. 8,187,427—Mixed Inclined Embossing Embossing Roller Assembly; U.S. Pat. No. 8,142,617—apparatus and method to degrade a web in the machine direction while preserving the steering force in the machine; U.S. Pat. No. 8,083,893—engraving process including discrete and linear engraving elements; U.S. Pat. No. 8,007,640—engraving process including discrete and linear engraving elements; U.S. Pat. No. 8,007,639—system for the production of an article made of tissue paper or the like comprising a superabsorbent material; U.S. Pat. No. 7,985,319—fabric product, method of manufacturing a fabric product and apparatus for embossing a fabric layer; U.S. Pat. No. 7,976,683—machine for the production of a fibrous web; U.S. Pat. No. 7,919,173—method for controlling a functional property of an industrial fabric and industrial fabric; U.S. Pat. No. 7,918,972—engraving process including discrete and linear recording elements; U.S. Pat. No. 7,914,649—papermaking belt for making paper structures; U.S. Pat. No. 7,887,676—engraving process including discrete and linear engraving elements; U.S. Pat. No. 7,871,498—fabrics for forming decorative fabric sheets; U.S. Pat. No. 7,799,176—Apparatus and method for degrading a web in the machine direction while preserving the steering force in the machine; U.S. Pat. No. 7,785,444—cylindrical suction box assembly; U.S. Pat. No. 7,758,728—corrugated needle-stitching fabric; U.S. Pat. No. 7,758,727—method for producing bulky fabric; U.S. Pat. No. 7,744,726—double wire for an ATMOS system; U.S. Pat. No. 7,704,351—processing device and method of operating the device for processing a coated or uncoated fibrous web; U.S. Pat. No. 7,524,404—engraving process including discrete and linear engraving elements; U.S. Pat. No. 7,481,643—convertible engraving device; U.S. Pat. No. 7,435,316—engraving process including discrete and linear engraving elements; U.S. Pat. No. 7,435,313—process for producing deep alignment embossed paper products; U.S. Pat. No. 7,427,334—method and apparatus for encoding substrates with information; U.S. Pat. No. 7,426,886—engraving device; U.S. Pat. No. 7,384,505—method of manufacturing a toilet paper product, apparatus for such manufacture and toilet paper product; U.S. Pat. No. 7,357,847—device for drying a paper web; U.S. Pat. No. 7,326,322—apparatus and method for degrading a web in the machine direction while preserving the steering force in the machine; U.S. Pat. No. 7,297,234—methods for joining structural elements of paper machines and industrial fabrics together and produced fabrics; U.S. Pat. No. 7,297,226—Apparatus and method for degrading a web in the machine direction while preserving the steering force in the machine; U.S. Pat. No. 7,265,067—Structured paper making apparatus; U.S. Pat. No. 7,182,838—apparatus and method for degrading a web in the machine direction while preserving the steering force in the machine; U.S. Pat. No. 7,022,208—Methods for joining structural elements of paper machines and industrial fabrics together and produced fabrics; U.S. Pat. No. 7,005,044—Method of manufacturing a strip and a strip used to make bulk towels, and nonwoven articles and fabrics; U.S. Pat. No. 6,926,308—toilet paper, paper towel and facial tissue; U.S. Pat. No. 6,846,172—engraving apparatus; U.S. Pat. No. 6,790,314—fabric for use in the manufacture of paper products with visually perceptible background texture regions delimited by curvilinear decorative elements and method thereof; U.S. Pat. No. 6,787,000—Fabric consisting of non-woven elements for use in the manufacture of paper products with visually discernible background texture regions surrounded by curvilinear decorative elements and their methods; U.S. Pat. No. 6,729,869—device for embossing a web of tissue paper; U.S. Pat. No. 6,706,152—fabric for use in the manufacture of paper products with visually perceptible background texture regions delimited by curvy decorative elements; U.S. Pat. No. 6,585,861—device for producing an extensible paper with a three-dimensional pattern; U.S. Pat. No. 6,578,617—device for embossing and laminating screen material consisting of two or more layers; U.S. Pat. No. 6,547,924—Paper machine and textured soft papermaking method; U.S. Pat. No. 6,475,346—apparatus for attaching at least one sheet of nonwoven fabric or paper, methods of implementing such an apparatus and article manufactured by such methods; U.S. Pat. No. 6,287,426—structured soft papermaking paper machine; U.S. Pat. No. 5,913,765—system and method for engraving a pattern to a consumer paper product; U.S. Pat. No. 5,736,223—multilayer printed papers and devices and methods for production; U.S. Pat. No. 5,562,805—method for making high volume soft fabric; U.S. Pat. No. 5,382,464—multilayer embossed paper and manufacturing method and apparatus; U.S. Pat. No. 4,978,565—absorbent laminated sheet and manufacturing process for such sheet; U.S. Pat. No. 4,849,054—high volume embossed fiber material and apparatus and method of manufacture thereof; U.S. Pat. No. 4,759,391—two-layer paper embossing fabric with depressions in the upper fabric layer for the production of tissue paper; U.S. Pat. No. 4,682,942—web-formed dry recording apparatus; U.S. Pat. No. 4,533,437—paper making machine; U.S. Pat. No. 4,144,124—Paper making machine, such as tissue paper; and U.S. Pat. No. 4,087,319—Method and means for sheet transfer and embossing in a winding station.

In general, existing pieces of equipment grant the means necessary so that two layers of tissue paper may be embossed and joined in an overlap to form a bulky and smooth paper, whether or not including a decorative stamping pattern on one or both layers; however, it was found that the embossing set (rollers) could be further improved, since there are currently no ways to define which is the best angle or placement of adjustment between reliefs of a layer and the reliefs of another layer, since the overlap of both layers is made on the side of the engraved paper.

In this condition, the greatest inconvenience in conventional equipment is, without a doubt, the lack of an angular mechanical arrangement to improve the placement of a relief layer in relation to another, i.e. an ideal angular arrangement between the reliefs of an embossing cylinder of the first layers and the reliefs of tan embossing cylinder of the second layer; consequently, the lack of said resource gives way to an undesirable placement between the reliefs of both layers and, with that, bumpy points are formed, which is a factor that is critical in reducing the quality of the final product, not only due to the roughness, but also due to compromising volume and, logically, the smoothness of the paper.

### OBJECTIVES OF THE INVENTION

An enhanced construction attempting specifically to characterize a singular constructive form, consisting of an angular arrangement between the rows of layers of both embossing rollers.

As previously stated, each embossing roller has a multitude of bulges or reliefs with a specific geometry, which could be, for instance, conical, pyramidal or another, including reliefs that form all sorts of figures or words convenient for the desired final product. Reliefs, regardless of their geometry, are distributed along the diameter of the embossing cylinder, forming parallel rows.

In order to obtain a more precise adjustment when both layers of embossed paper are overlapped, the present invention includes an innovation through an angular positioning arrangement between the relief rows of the embossing rollers. In this condition, the distribution of reliefs, though identical to that of the other embossing role, is shifted according to a combination angle that varies from 4° to 13° degrees; the embossing rollers are built within this range, whereas this shift may be determined by software or graphically (digital images).

As previously stated, the angular adjustment between the relief rows of the embossing rollers is between 4° and 13° degrees; logically, the variation occurs in accordance with multiple factors, such as: the amount of reliefs (points/cm²), the geometry adopted for them and other dimensional and geometric factors.

Once the angular adjustment is determined, the embossed layers grant the means necessary so that their overlap may ensure a perfect fitting integration between both layers, i.e. the reliefs of a layer fit between the reliefs of the other layer with more precision, and the conic nature of the reliefs allows both layers to be slightly separate, consequently, multiple technical and practical advantages are obtained, including: virtual elimination of rough points; considerable increase in volume; considerable increase in softness; the sum of said characteristics improving tactile feel and making it more pleasant; and the sum of said details providing means to vary the visual aspect of the resulting texture; consequently, with the variation of the degree used alone, it is possible to change the design of the final paper texture.

### DESCRIPTION OF THE DRAWINGS

To better understand the assembly, what follows is a detailed description of it, with reference to the attached drawings:

FIG. 01 represents a schematic side view of a machine with enhanced embossing rollers according to the present invention for two layers of paper;

FIG. 02 shows expanded details of the embossing profile and the joining of both embossed paper layers;

FIG. 03 shows two embossing rollers emphasizing the angular shift of the parallel relief rows;

FIG. 04 schematically illustrates the plain surface of the two embossing rollers, emphasizing the angular shift of the parallel embossing relief rows;

FIG. 05 is a view identical to the previous one, emphasizing the fact that the angular variation of the relief rows of both embossing rollers allows for a variation in the design of the resulting paper's texture; and

FIG. 06 shows a perspective view solely to provide an example of one of many products obtained with the present invention.

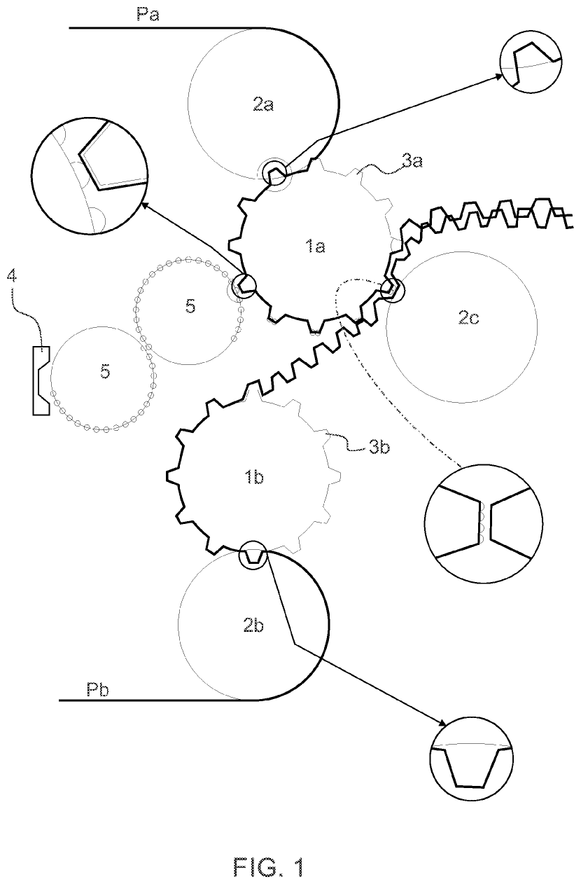

According to these illustrations and their details, particularly FIG. 01, the present IMPROVEMENT TO AN EMBOSSING ASSEMBLY FOR PAPER PROCESSING presents a preferred embodiment defined by two embossing rollers (1a) and (1b) that are independent and assembled in parallel one from another, and each has its own press roller (2a) and (2b), forming two embossing lines for two layers of paper (Pa) and (Pb).

Both embossing rollers (1a) and (1b) have their diameters with a multitude of reliefs (3a) and (3b) with a specific geometry, which could be, for instance, conical, pyramidal or another, including reliefs that form all sorts of figures or words convenient for the desired final product. Reliefs, regardless of their geometry, are distributed along the diameters of the embossing cylinders (1a) and (1b), forming parallel rows.

For the embossing of both paper layers (Pa) and (Pb), they pass between the respective pairs of embossing rollers (1a-1b) and press rollers (2a-2b). Notice that the paper layers (Pa) and (Pb) are mirrored and the reliefs of both are turned against one another to be overlapped.

At least one of the embossing lines includes a glue applying station (4) with glue transferring rollers (5), one of which is in contact with the corresponding embossing roller (1a) at one point after the corresponding press roller (2a), so that the glue can be applied to the paper layer (Pa) while it is in said embossing roller (1a).

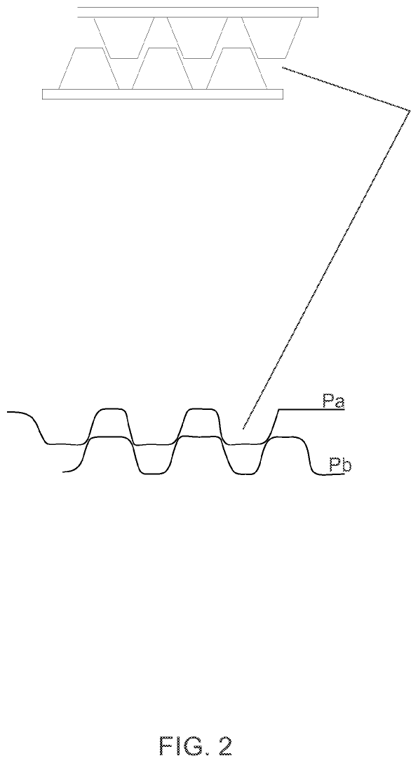

A third press roller (2c) works with the first embossing roller (1a) and, at that point, both paper layers (Pa) and (Pb) already embossed and overlapped, pass through, are fitted between themselves and glued together. At this point (see FIG. 2), notice that the mirrored paper layers (Pa) and (Pb) are juxtaposed and there is an integration between them in order for there to be a fitting of the reliefs of each one, a fitting that is not completed due to the conic geometry of each, consequently, the paper layers (Pa) and (Pb) are separate from each other, however, the reliefs fit and remain in this position due to the glue points.

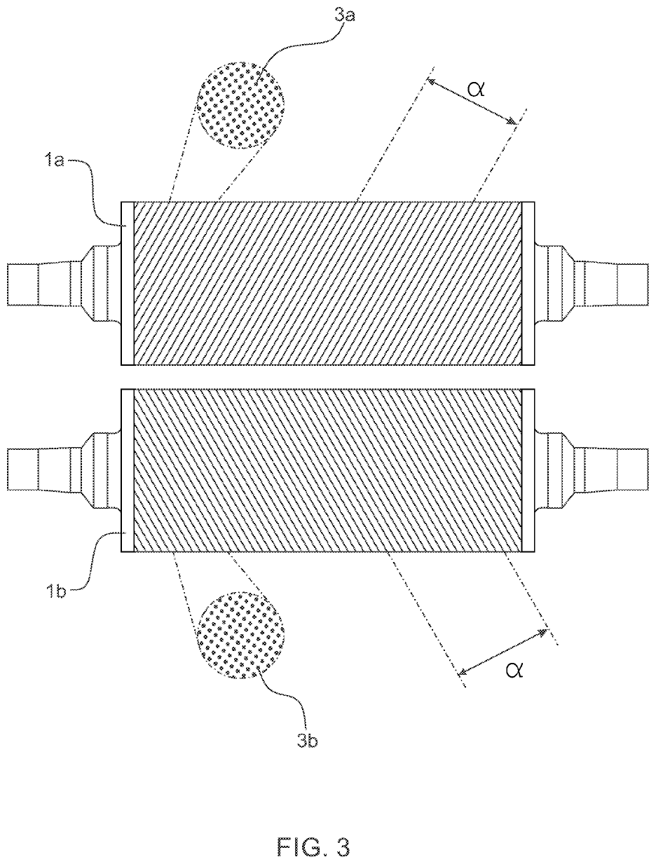

In relation to the FIGS. 3, 4 and 5, the precision of the integration between both paper layers (Pa) and (Pb) occurs due to an angular specificity (α) previously defined between the rows of reliefs (3a) and (3b) of the embossing cylinders (1a-1b).

The angular definition (α), as previously stated, is established according to each project, for it considers different factors, not just dimensions but also those inherent to the chosen geometry, as well as any irregular forms that are obtained through the embossing of marks and drawings.

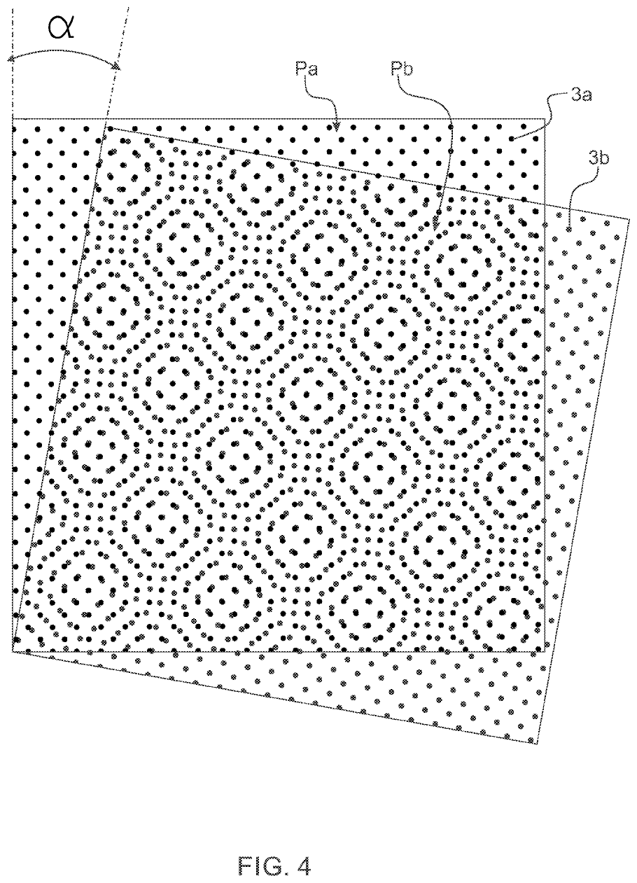

The angular definition is illustrated with details in FIGS. 3 and 4, through which it is verified that the invention is characterized by the fact that the parallel rows of reliefs (3a) and reliefs (3b) of the embossing roller (1a) and embossing roller (1b) present an angular shift (α) preferably between 4° and 13° degrees.

The angular shift may be obtained with a shift angle (α) of solely reliefs (3a) or (3b) of one or both embossing rollers (1a) or (1b).

The final angular shift may be the sum of the shift angles of the reliefs (3a) and (3b) of both embossing rollers (1a) and (1b).

The study of the angular shift (α) may be performed through known means, through software or using digital or physical graphical simulations.

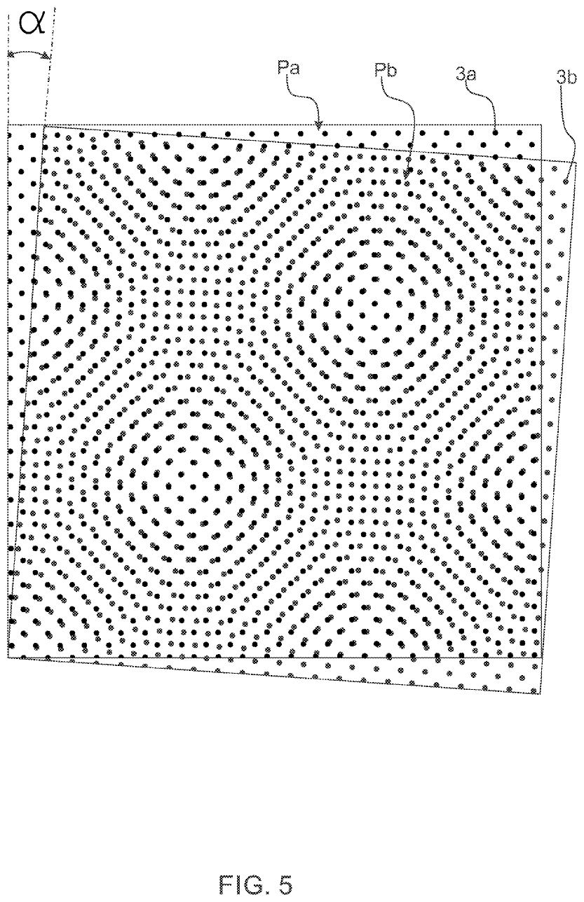

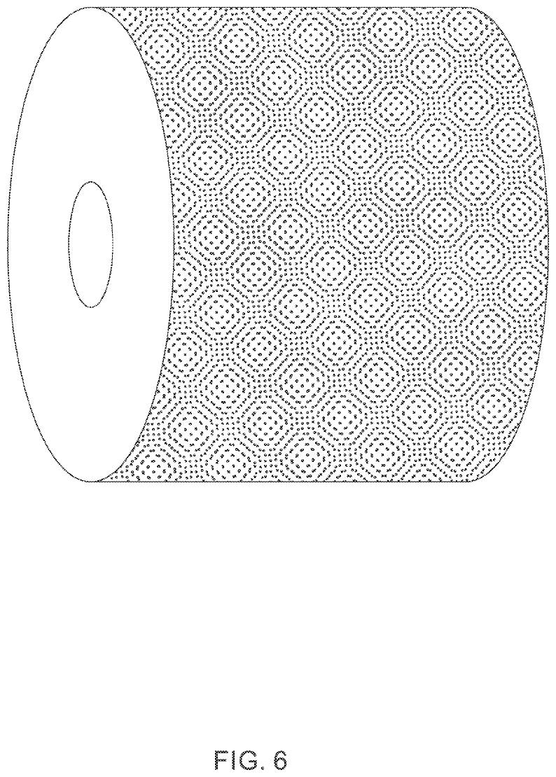

As one may notice, after what has been exposed and illustrated, the angular shift (α) makes it possible to establish the best form of construction for the embossing rollers (1a) and (1b), which results in paper embossing layers (Pa) and (Pb), which may be joined in an overlap, and the reliefs (3a) and (3b) combine for the best fit within each other (FIG. 2) and, in the end, the previously stated advantages are achieved: a practical elimination of rough points, considerable increase in volume; and considerable increase of softness. The sum of said characteristics improves the tactile feel and makes it more pleasant; also, the angular variation (α) between the reliefs, as shown in FIGS. 5 and 6, grants means to vary the design of the tecture of the final product, which, as stated, may be any article that requires the use of sheets with the aforementioned characteristics, especially: toilet paper, paper towels, paper tissue and others.

1) IMPROVEMENT TO AN EMBOSSING ASSEMBLY FOR PAPER PROCESSING, comprising two independent embossing rollers (1a) and (1b), assembled in parallel with each other, with each having its own press roller (2a) and (2b) , forming two embossing lines, for two layers of paper (Pa) and (Pb); the two embossing rollers (1a) and (1b) have their diameters with reliefs (3a) and (3b) distributed on the diameters of the embossing cylinders (1a) and (1b), forming parallel rows on which the embossing of two paper layers (Pa) and (Pb) is made between the respective pairs of embossing rollers (1a-1b) and press rollers (2a-2b); at least one of the embossing lines includes a glue applying station (4) with glue transferring rollers (5), one of which is in contact with the corresponding embossing roller (1a) at a point after the corresponding press roller (2a); a third press roller (2c) works with the first embossing roller (1a) and, at this point, the two paper layers (Pa) and (Pb) pass, already embossed and overlapped, fitted between themselves and glued, whereas at this point the mirrored paper layers (Pa) and (Pb) are overlapped and there is an integration between them in order for the reliefs to fit within each other, a fitting that is not completed due to the conic geometry of each; consequently, the paper layers (Pa) and (Pb) are separate from each other, however, the reliefs are fitted and remain at this position due to the glue points; characterized by the fact that the parallel relief rows (3a) and reliefs (3b) of the embossing roller (1a) and the embossing roller (1b) present an angular shift (α).

2) IMPROVEMENT TO AN EMBOSSING ASSEMBLY FOR PAPER PROCESSING, according to claim 1, characterized by the fact that the angular shift is obtained according to a shift angle (α) of solely reliefs (3a) or (3b) of one or both embossing rollers (1a) or (1b).

3) IMPROVEMENT TO AN EMBOSSING ASSEMBLY FOR PAPER PROCESSING, according to claim 1, characterized by the fact that the final angular shift may be the sum of the shift angles of the reliefs (3a) and (3b) of both embossing rollers (1a) and (1b).
